(19) United States
(12) Patent Application Publication
(10) Pub. No.: US 2010/0141455 A1
(43) Pub. Date: Jun. 10, 2010

(54) ANTI-THEFT DEVICE

(76) Inventor: Paolo Stefanelli, Milano (IT)

Correspondence Address: Pearne & Gordon LLP, 1801 East 9th Street, Suite 1200, Cleveland, OH, 44114-3108, US

(21) Appl. No.: 12/519,722

(22) PCT Filed: Dec. 18, 2006
(86) PCT No.: PCT/IT2006/000855

§ 371 Date: Jan. 7, 2010

(51) Int. Cl. G08B 13/14

(52) U.S. Cl. 340/572.8

(57) ABSTRACT

An anti-theft device comprising a main body (10) ; a circuit (20) at least partly housed in said main body (10) and designed to receive a request signal (100) and generate a corresponding response signal (110); an elongated element (30) attach to said main body (10) and extending at least partly externally of the main body (10) itself to define an annular structure (30a) suitable for engagement with a product (2) to be monitored. The elongated element (30) is part of said circuit (20). Also disclosed is a process for producing said device (1) and a goods-monitoring system, in particular a safety system, incorporating said device (1).

The present invention relates to an anti-theft device.

The present invention also relates to a process for producing such an anti-theft device, as well as to a goods-monitoring system, in particular a safety system, incorporating such a device.

It is known that currently used for the goods to be put on the market, and in particular for jewellery articles, are data plates which have a dual purpose, i.e. reproducing the brand name, model, price and possible other description data of the goods with which said plates are associated, and preventing said goods from being stolen or in any case removed in an illegal and uncontrolled manner from the area where they must stay.

The anti-theft action or shoplifting-preventing action is obtained due to a circuit housed within the plate; this circuit generally comprises a memory in which an identification code of the goods or products is contained, a transmission module to generate a signal incorporating at least said identification code, and an antenna for transmission of said signal.

As far as the goods and related plates are in a predetermined suitably monitored area, the circuit talks to the monitoring system at a predetermined frequency so that the monitoring system will have a continuous confirmation of the presence of the goods in the predetermined area. When the system does no longer detect the presence of the plate (and therefore presumably of the goods associated therewith), it generates a suitable signal to keep trace of this absence.

If a subsequent registration of a sale operation corresponds to the absence of the plate and the goods associated therewith, the control activity of the system will be terminated. If, on the contrary, no sale operation corresponds to the absence of the plate, the system generates an alarm signal to warn about an anomalous situation.

Typically, a data plate of known type is secured to the respective product through gluing, sewing, or by means of a String introduced into a through cavity, elongated hole, or annular structure of the product. We will mention, by way of example, rings or watches into which said string can be introduced for mutual engagement with the respective plate.

However, it is apparent that the systems of known type such as those described above can be easily eluded through separation of the plate from the respective product, leaving the plate in a suitable position within the monitored area. In this way, the system will not be able to detect the absence of the product, exactly because the corresponding plate or label is in the pre-established place, so that no anomaly can be found.

In particular, in the case of plates in engagement with the goods through a string, it can be very easy and quick to tear or cut off said string, thus stealing the product without the monitoring system becoming aware of the fact.

Accordingly, it is an object of the present invention to make available an anti-theft device that can be engaged to the respective goods in a more reliable manner.

It is another object of the invention to provide a device enabling safer monitoring and control processes to be carried into effect, as compared with those made available by the known art.

A further object of the invention is to provide a device of simple construction structure and limited manufacturing costs, which substantially has the same bulkiness as known devices while offering a greater reliability.

The foregoing and still further objects are substantially achieved by an anti-theft device in accordance with the features recited in the appended claims.

Further features and advantages will become more apparent from the detailed description of a preferred but not exclusive embodiment of a device in accordance with the invention.

This description is taken hereinafter with reference to the accompanying drawings, given by way of non-limiting example, in which:

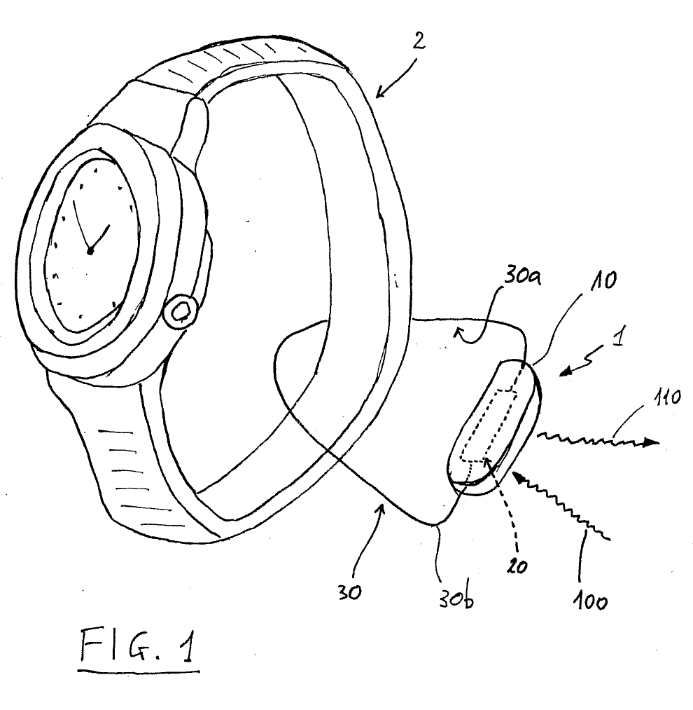

FIG. 1 diagrammatically shows a device in accordance with the invention in its use conditions;

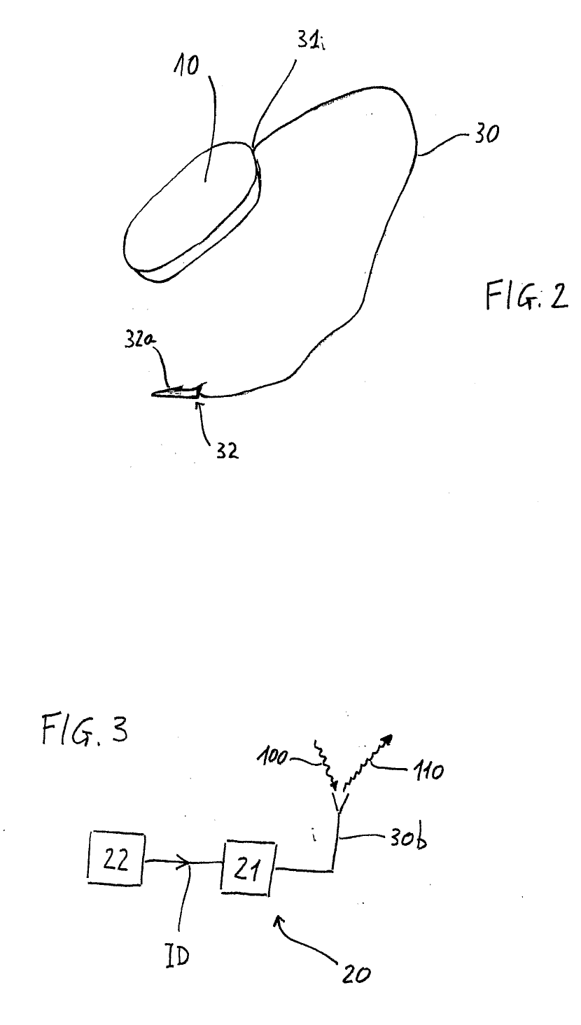

FIG. 2 diagrammatically shows a possible embodiment of the device seen in FIG. 1;

FIG. 3 is a block diagram of a circuit being part of the device seen in FIG. 1;

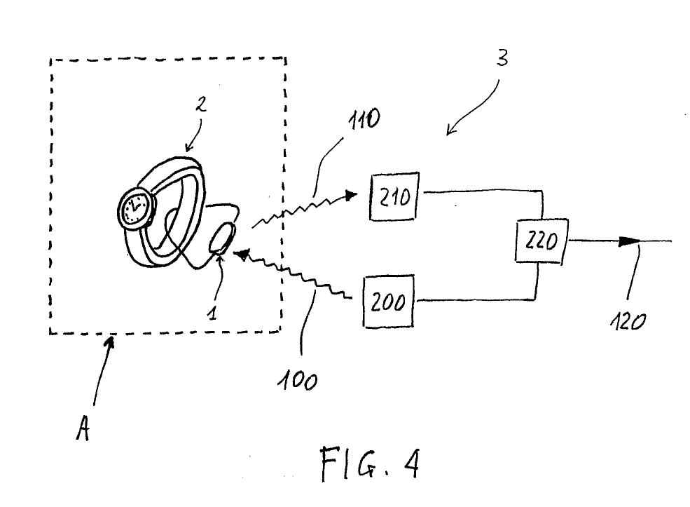

FIG. 4 is a block diagram of a system in which the device seen in FIG. 1 is used.

With reference to the drawings, an anti-theft device in accordance with the present invention has been generally identified with reference numeral 1.

Device 1 (FIGS. 1-3) first of all comprises a main body 10. Said main body 10 can be made of plastic material, paper or paperboard material, etc., for example; generally the main body 10 can be manufactured using any material suitable for obtaining a data plate or label to be engaged to a product 2 that must be kept under control.

The main body 10 can be substantially shaped like a parallelepiped or a prism; it can also have a plate-like conformation.

Preferably inscriptions indicating the brand name, price, and possibly other important information concerning the product 2 are positioned on one or more surfaces of the main body 10.

Device 1 further comprises a circuit 20 at least partly housed in the main body 10.

Circuit 20 is designed to receive a request signal 100 and to generate a corresponding response signal 110.

The request signal 100 preferably defines an electromagnetic field in which the device 1 and product 2 associated therewith are under conditions of normal use.

In FIG. 1, the product 2 associated with device 1 is by way of example, a watch; clearly the device 1 in accordance with the invention can be attached to any goods provided with a through cavity, an elongated hole, or a generic annular structure suitable for linking with the annular structure 30a of the device 1 itself (to be described in the following).

With reference to FIG. 4, denoted at A is the area that is monitored and in which therefore propagation of the request signal 100 takes place.

The electromagnetic field generated by the request signal 100 carries out powering of circuit 20 which is activated and consequently generates the response signal 110.

Circuit 20 can be made as a TAG ISO for example, operating at 13.56 MHz, or as a TAG UHF; the latter can be in particular very useful in case of very remote readings.

Preferably, circuit 20 is provided with a transmission module 21 to generate the response signal 110.

Preferably, circuit 20 further comprises a memory 22 to contain an identification code ID univocally associated with the product 2. In other words, associated with the product 2 is an identification code ID enabling the same to be recognised even among a plurality of quite identical products; this identification code ID is stored in the memory 22 of circuit 20.

In the preferred embodiment, memory 22 is operatively associated with the transmission module 21 to incorporate the identification code ID into the response signal 110. In this manner, since the monitoring system (to be described in the following) recognises the different identification codes of the devices present in area A, it always knows whether these devices are present and therefore can detect the absence of one or more of same, which presumably also involves the absence of the goods associated therewith.

Device 1 further comprises an elongated element 30 attached to the main body 10 and extending at least partly at the outside of the main body 10 itself. The elongated element 30 in co-operation with the main body 10 defines a closed annular structure 30a suitable for engagement with the product 2 associated with device 1. In this manner device 1 can remain attached to the respective product 2.

The elongated element 30 has a first and a second ends 31, 32; said ends are secured to the main body 10. Preferably at least one of the two ends 31, 32 of the elongated element 30 is secured to the main body 10 in a removable manner; in this way the step of attaching device 1 to the product 2 is facilitated.

In addition, when use of the device 1 is over, the same Can be detached from the product 2 and reused for another product, possibly updating the identification code contained in memory 22. In particular, both ends 31, 32 can be removably engaged to the main body 10.

FIG. 2 shows by way of example, the device 1 in which the second end 32 of the elongated element 30 is disengaged from the main body 10.

To be noted at said second end 32 is a suitable connector 32a adapted to be inserted into a respective seat (not shown) of the main body 10 so that it will be secured thereto.

For mutual engagement of device 1 and product 2, before at least one of the ends 31, 32 is secured to the main body 10, the elongated element 30 is inserted into a through cavity or elongated hole or annular structure of the product 2.

Subsequently, the end that was not yet in engagement with the main body 10 is secured to said main body 10 so that device 1 is attached to the product 2 in the same manner as two consecutive links of a chain.

The elongated element 30 is part of circuit 20. This means that the elongated element 30 is directly or indirectly connected to the other components of circuit 20 to enable correct operation of same.

Practically the elongated element 30 can be an electrically conductive wire, in, engagement with the main body 10 and electrically connected to the other circuit elements. In more detail the above mentioned ends 31, 32 of the elongated element 30 in addition to being mechanically linked to the main body 10, are also electrically connected to the remaining part of circuit 20, so as to “close” the circuit 20 itself and enable operation of same when suitably powered.

In the preferred embodiment the elongated element 30 is an antenna 30b of circuit 20. By means of the antenna 30b, circuit 20 through the request signal 100 receives the energy necessary to feed the transmission module 21 for generation of the response signal 110.

Preferably the antenna 30b is also used for transmission of the response signal 110.

The length of the elongated element 30 will be such defined as to enable the latter to interact with the request signal 100 at the frequency of said request signal and preferably to transmit the response signal 110 at the desired frequency.

Should an individual try to steal the product removing it from the predetermined area A, two opportunities would arise:

he/she could simultaneously remove the product 2 and device 1 trying then to go away, but the absence of device 1 would be noticed because the system would not receive the corresponding response signal 110 any longer;

he/she could detach device 1 from the product 2 and try to move away carrying the product 2 alone with himself/herself; however, for separating device 1 from the product 2 it would be necessary to break the elongated element 30 thus inhibiting correct operation of circuit 20 that can no longer generate the response signal 100. Therefore in this case too generation of the response signal 110 will be stopped and the system will be able to detect the anomalous situation.

System 3 (FIG. 4) in which device 1 operates preferably comprises a generation module 200 for generating the request signal 100 that is suitably addressed to the predetermined area A where the product 2 is positioned and from which said product 2 cannot be removed without authorisation.

System 3 will comprise one or more anti-theft devices 1 like the one described above; each device 1 is connected to a respective product 2 to be monitored. Each device 1, as already described, is designed to generate a response signal 110 following reception of the request signal 100.

System 3 further comprises a reception module 210 to detect the response signal/s 110 generated by said one or more anti-theft devices 1.

System 3 also comprises a control unit 220 operatively associated with at least the reception module 210 and preferably also with the generation module 200 to control reception of the response signals 110.

Should one or more response signals 110 not be received by the reception module 220 within a predetermined time interval, the control module will generate a notification signal 120.

The notification signal 120 can be addressed to a local receiver, positioned within the shop where area A is defined for example, to warn the shop assistants and/or the concerned staff that an anomalous situation is taking place.

In addition or alternatively, the notification signal 120 can be addressed to a remote receiver associated with a processor remotely managing the different situations that may occur in area A.

Preferably the notification signal 120 is an alarm signal capable of informing the addressee of the information as quickly as possible.

Advantageously, device 1 can also be employed for control of the goods flow from the manufacturing/production step to the retailing step, until the cash desk.

Device 1 further enables variations in the goods in stock or stored in other storage areas to be followed and controlled in real time.

Therefore, the notification signal 120 can also not be an alarm signal, but merely a signal enabling an automated control system to keep trace of the displacements of a given device 1 and the associated product 2.

For accomplishment of device 1 the following steps are required.

First of all the main body 10 and circuit 20 are suitably provided. Circuit 20 is at least partly housed within the main body 10. The elongated element 30 is therefore in engagement with the main body 10 in such a manner that it extends at least partly externally of the main body 10. In more detail, the ends 31, 32 of the elongated element 30 are secured to the main body 10. Preferably at least one of the ends 31, 32 is linked to the main body 10 in a removable manner. In a preferred embodiment, both ends 31, 32 are engaged to the main body 10 in a removable manner. In co-operation with the main body 10, the elongated element 30 defines said annular structure 30a. As above specified, the annular structure 30a is suitable for engagement with the product 2 so as to enable monitoring of the latter.

The invention achieves important advantages.

The device in accordance with the invention in fact can be linked to the product associated therewith in a very reliable manner, since the monitoring system due to the device being the object of the invention is put in a condition to immediately detect a possible separation between the device and the product.

In addition, more reliability in the whole control system is achieved since said system is able to efficiently detect possible theft attempts or unauthorised displacements.

Other advantages reside in that the device of the invention has a simple construction structure, reduced production costs and the same bulkiness as known devices while offering more reliability than the latter.

1. An anti-theft device comprising:
a main body (10);
a circuit (20) at least partly housed in said main body (10) and designed to receive a request signal (100) and generate a corresponding response signal (110);
an elongated element (30) attached to said main body (10) and extending at least partly externally of the main body (10) itself to define an annular structure (30a) suitable for engagement with a product (2) to be monitored,
wherein said elongated element (30) is part of said circuit (20).

2. A device as claimed in claim 1, wherein said elongated element (30) is an antenna (30b) of said circuit (20).

3. A device as claimed in claim 1, wherein said elongated element (30) has a first and a second ends (31, 32) secured to said main body (10).

4. A device as claimed in claim 3, wherein at least one of said ends (31, 32) is secured to said main body (10) in a removable manner.

5. A device as claimed in claim 4, wherein both said ends (31, 32) are secured to said main body (10) in a removable manner.

6. A device as claimed in claim 1, wherein said circuit (20) comprises a transmission module (21) for generating said response signal (110).

7. A device as claimed in claim 6, wherein said circuit further comprises a memory (22) to contain an identification code (ID) preferably univocally associated with said product (2).

8. A device as claimed in claim 7, wherein said memory (22) is operatively associated with said transmission module (21) for incorporating said identification code (ID) into said response signal (110).

9. (canceled)

10. A process for attaching an anti-theft device to a product to be monitored, comprising:
providing an anti-theft device (1) as claimed in claim 1;
introducing said elongated element (30) into a through cavity, or elongated hole, or annular structure of a product (2) to be monitored.

11. A process as claimed in claim 10, wherein the step of introducing said elongated element (30) into said through cavity, or elongated hole, or annular structure is performed before securing at least one of said ends (31, 32) of said elongated element (30) to said main body (10).

12. A process for producing an anti-theft device, comprising the following steps:
providing a main body (10);
providing a circuit (20) designed to receive a request signal (100) and generate a corresponding response signal (110);
housing said circuit (20) at least partly in said main body (10);
attaching an elongated element (30) to said main body (10) in such a manner that said elongated element (30) extends at least partly externally of said main body (10) and defines an annular structure (30a) suitable for engagement with a product (2) to be monitored, said elongated element (30) being part of said circuit (20).

13. A process as claimed in claim 12, wherein said elongated element (30) is an antenna (30b) of said circuit (20).

14. A process as claimed in claim 12, wherein the step of attaching said elongated element (30) to said main body (10) comprises a sub-step of securing a first end and a second end (31, 32) of said elongated element (30) to said main body (10).

15. A process as claimed in claim 14, wherein at least one of said ends (31, 32) is secured to said main body (10) in a removable manner.

16. A process as claimed in claim 15, wherein both ends (31, 32) are secured to said main body (10) in a removable manner.

17. A process as claimed in claim 12, wherein said circuit (20) comprises a transmission module (21) for generating said response signal (110).

18. A process as claimed in claim 17, wherein said circuit (20) further comprises a memory (22) designed to contain an identification code (ID) associated with said product (2) preferably univocally.

19. A process as claimed in claim 18, wherein said memory (22) is operatively associated with said transmission module (21) in order to incorporate said identification code (ID) in said response signal (110).

20. A monitoring system for goods, in particular a safety system, comprising:
a generation module (200) for generating a request signal (100) addressed to a predetermined area (A);
one or more anti-theft devices (1) as claimed in claim 1, each engaged to a respective product (2) to be monitored and designed to generate said response signal (110) following reception of said request signal (100);
a reception module (210) for detecting the response signal/s (110) generated by said one or more anti-theft devices (1);
a control unit (220) operatively associated with at least said reception module (210) to control reception of said response signal/s (110) and generate a notification signal (120) if at least one predetermined signal among said response signals (110) is not received within a predetermined time interval.
